(19) United States
(12) Patent Application Publication
(10) Pub. No.: US 2025/0128221 A1
(43) Pub. Date: Apr. 24, 2025

(54) ADAPTIVE MIXING SYSTEM

(71) Applicant: ZIMPLISTIC PRIVATE LIMITED, Singapore (SG)

(72) Inventors: Pranoti Nagarkar ISRANI, Bangalore (IN); Rishi ISRANI, Bangalore (IN)

(73) Assignee: ZIMPLISTIC PRIVATE LIMITED, Singapore (SG)

(21) Appl. No.: 18/839,977

(22) PCT Filed: Feb. 21, 2023
(86) PCT No.: PCT/SG2023/050103

§ 371 Date: Aug. 20, 2024

(30) Foreign Application Priority Data
Feb. 21, 2022 (SG) 10202201693X

(51) Int. Cl. B01F 35/88; A21C 1/14; B01F 35/22; B01F 101/08

(52) U.S. Cl. CPC B01F 35/881; A21C 1/1425; A21C 1/146; B01F 35/2202; B01F 2101/08

(57) ABSTRACT

Disclosed is an adaptive mixing system. The system comprises: dispensers for dispensing ingredients; a mixing unit for receiving and mixing the dispensed ingredients to form a mixture; a weighing device associated with the mixing unit, to weigh amounts of the ingredients received in the mixing unit; and a control system configured to cause the dispensers to dispense a predetermined weight, as measured by the weighing device, of each ingredient. The control system is configured to determine a consistency of the mixture based on measurements from one or both of the mixing unit and the weighing device; compare the consistency to a reference consistency to determine if the consistency and reference consistency are a match, and in the absence of a match, to cause an additional weight of the ingredient(s) to be dispensed to result in such as match.

### FIELD OF THE INVENTION

The present invention relates to an adaptive mixing system. More particularly, the present invention relates to an adaptive mixing system for adjusting the weights of ingredients depending on the consistency of a mixture. The present invention also relates to an apparatus for making flat edibles, comprising such an adaptive mixing system.

### BACKGROUND OF THE INVENTION

Flat edibles such as roti, tortilla, flatbreads and pita are part of the common diet in many different cultures. These flat edibles are typically best eaten when made fresh and, as such, they are typically prepared before each meal.

Flat edibles are generally made by hand due to the variation in quantities of ingredients required depending on, for example, flour type, oil type and other factors. Consequently, preparation prior to each meal can be tedious and time consuming.

The process of making a flat edible by hand often also requires minor adjustments by the baker during the kneading process depending on external conditions such as ambient humidity and type of quality of ingredients. As such, it is difficult to formulate a fixed recipe of making flat edibles, that accounts for the variation in cooking conditions and ingredients.

Making a flat edible with the right consistency typically requires the baker to feel the consistency of the dough, for example during the process of kneading the dough. If the consistency does not feel right e.g. too soft or too hard, the baker can adjust the recipe accordingly. This requires the baker to have a certain amount of skill and experience.

It is therefore difficult for a person new to making flat edibles, to consistently make flat edibles with the right consistency and texture.

It is generally desirable to overcome or ameliorate one or more of the above described difficulties, or to at least provide a useful alternative.

### SUMMARY OF THE INVENTION

Disclosed is an adaptive mixing system for use in producing flat edibles, comprising:
(a) two or more dispensers for dispensing two or more ingredients;
(b) a mixing unit for receiving and mixing the dispensed two or more ingredients to form a mixture;
(c) a weighing device associated with the mixing unit, to weigh amounts of ingredients received in the mixing unit; and
(d) a control system configured to cause the two or more dispensers to dispense a predetermined weight, as measured by the weighing device, of each ingredient of the two or more ingredients,
wherein the control system is further configured to:
   (i) determine a consistency of the mixture based on measurements from one or both of the mixing unit and the weighing device;
   (ii) compare the consistency to a reference consistency to determine if the consistency and reference consistency are a match;
   (iii) if the consistency and the reference consistency are not a match, determine an additional weight of one or more of the ingredients, to be dispensed by the dispensers, required so that the consistency approaches or matches the reference consistency; and
   (iv) cause the additional weight of the respective ingredients to be dispensed.

The additional weight in each case may be determined by the control system based on a consistency of the mixture as measured by the weighing device and a consistency profile.

The mixing unit may be one or more of the following:
(a) a kneading unit;
(b) a rolling unit; and
(c) a processing unit.

The reference consistency may be a consistency range and the control system may then determine if the consistency and reference consistency are a match by determining if the consistency is within the consistency range. The reference consistency may comprise a time-based profile and, at one or more time-periods (or time points) during mixing, the control system determines if the consistency and reference consistency are a match by determining if the consistency is within the consistency range applicable at a corresponding said time period.

The weighing device may further be configured to measure the consistency of the mixture after the step of mixing the dispensed two or more ingredients to form a mixture.

The control system may perform steps (i) and (ii) on two or more occasions during mixing, and performs steps (iii) and (iv) if step (ii) determines, on each respective occasion, that there is not a match.

Upon completion of mixing of the mixture, the control system may update the amounts of the two or more ingredients based on the additional weight for each respective ingredient, dispensed during mixing. The additional weight may be a total additional weight of each respective ingredient dispensed on all occasions during mixing. The control system may update the amounts by:
determining a total weight of each ingredient required for the consistency to match during mixing; and
normalising the ingredients based on a predetermined total mixture weight.

Also disclosed is an apparatus for producing flat edibles comprising the system as described above.

The apparatus may further include a flattening mechanism for flattening the mixture to form a flattened mixture. The flattening mechanism may include a first plate and a second plate movable with respect to the first plate, to flatten the mixture.

The apparatus may further include a heating mechanism for heating the flattened mixture to obtain a cooked flat edible. The heating mechanism may comprise a radiant heat source.

The apparatus may further comprise a transfer mechanism for transferring the flat edible from the apparatus. The transfer mechanism may be configured to transfer the mixture from the mixing unit to the flattening mechanism. The transfer mechanism may be configured to place the mixture on a pre-determined location with respect to the flattening mechanism. The transfer mechanism may comprise a surface shaped to at least partially surround the mixture and push the mixture to the flattening mechanism.

Advantageously, the adaptive mixing system enables the quantities of ingredients in a doughball or mixture to be automatically and dynamically updated to ensure a particular consistency of mixture is achieved. Embodiments of the system also automatically update the mixture parameters (e.g. weights of ingredients) for use in future cooking cycles.

### BRIEF DESCRIPTION OF THE DRAWINGS

Preferred embodiments of the invention are hereafter described, by way of non-limiting example only, with reference to the accompanying drawings, in which:

FIG. 1 is an apparatus for making flat edibles, incorporating an adaptive mixing system (also herein referred to as an adaptive kneading system) in accordance with present teachings;

FIG. 2 is a computer system representation of the apparatus of FIG. 1, for controlling various processes performed by that apparatus;

FIG. 3 is a further apparatus for making flat edibles showing (removable) dispenser containers removed;

FIGS. 4A and 4B are top and bottom perspective views of a dispenser and mixing unit;

FIG. 5 is a cross-section view of a dispenser used with the adaptive mixing system disclosed herein;

FIG. 6 is a cross-section view of a mixing unit;

FIG. 7 is a processing member of a mixing unit in accordance with present teachings;

FIG. 8 shows a mixing or kneading profile by which the control system make controls decisions; and

FIG. 9 shows a cross-section of an apparatus for making flat edibles, using a mixing unit according to present teachings.

### DETAILED DESCRIPTION OF EMBODIMENTS OF THE INVENTION

Embodiments of the present adaptive mixing system, and apparatus for making flat edibles incorporating that adaptive mixing system, can compensate for, or correct, inconsistencies in a dough ball or other mixture—e.g. that which is cooked to form the flat edible. These embodiments can thereby produce a consistent and repeatable flat edible of the desired texture.

As described hereafter, the terms “flat edible”, “cooked flat edible” and “roti” may be used interchangeably. It will be understood, however, that the flat edible may be a product other than a roti, without falling outside the scope of the present disclosure. The term “roti”, where used, is for illustration purposes only.

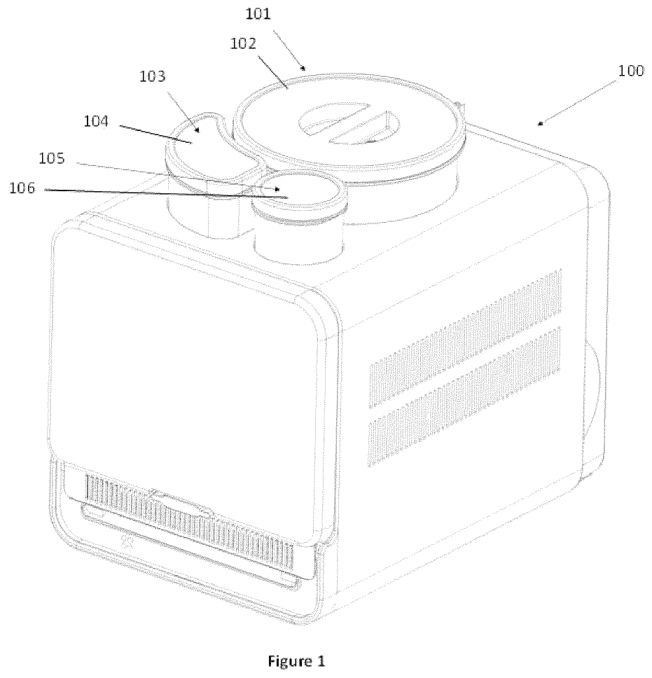

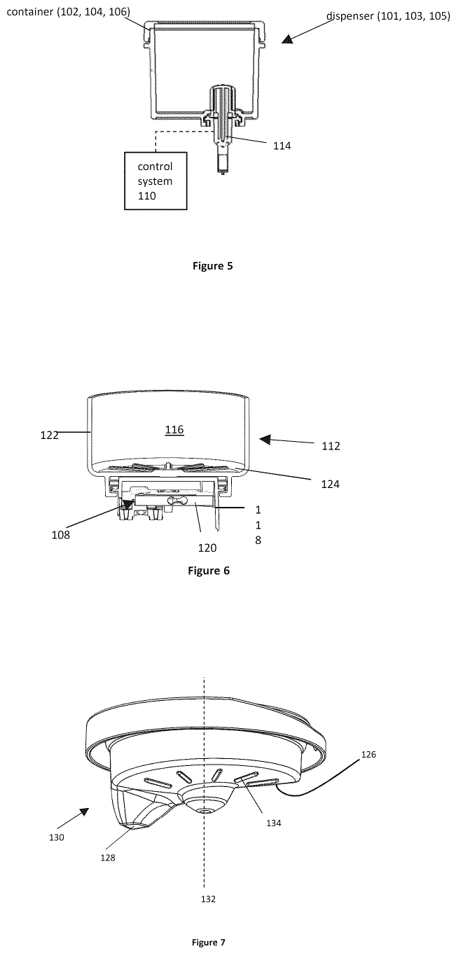

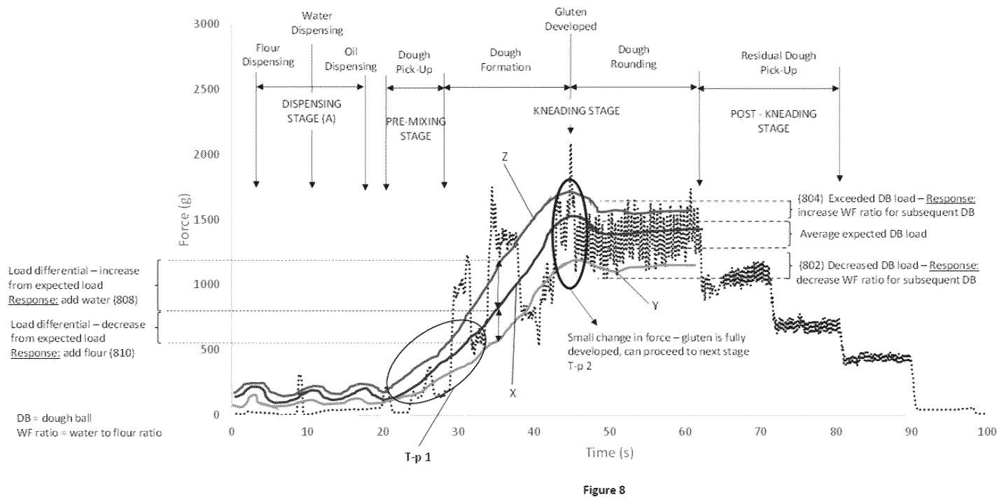

With reference to FIG. 1, an apparatus 100 for producing flat edibles is shown. Broadly, the apparatus 100 includes:
(a) two or more dispensers 101, 103, 105 each of which is associated with a container 102, 104, 106;
(b) a weighing device 108 (see FIG. 6);
(c) a control system 110 (see FIG. 4A); and
(d) a mixing unit 112 (see FIG. 4A).

Limited to these components, the apparatus 100 can be used for—as in, in the process of—making flat edibles. As discussed below, under control of the control system 110, the apparatus 100 will produce a consistent mixture that can be cooked to produce the flat edible. In some embodiments, the apparatus 100 itself also operates to cook the mixture into a flat edible.

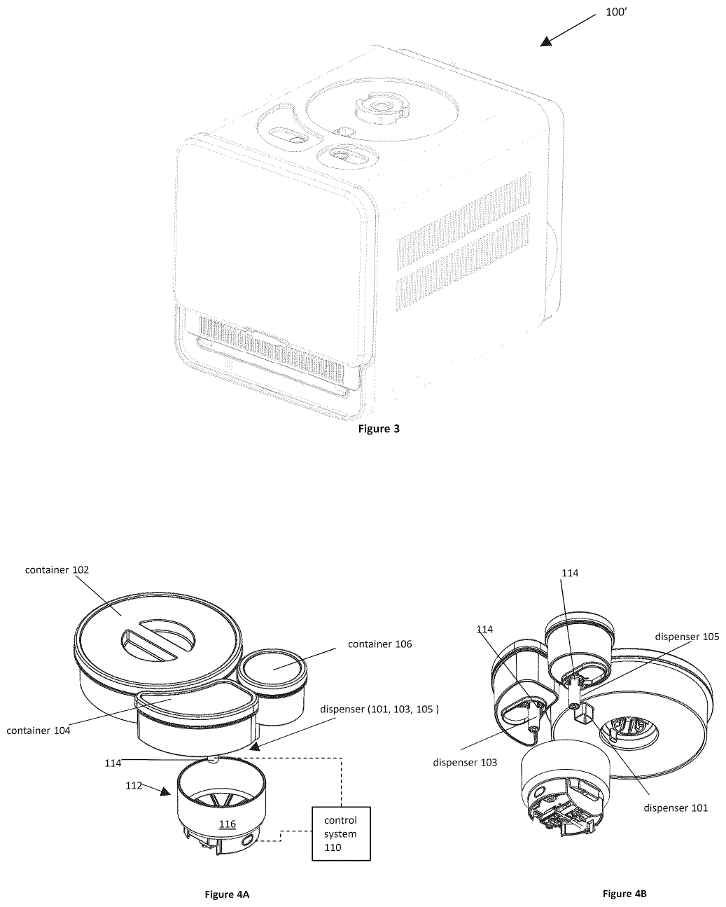

FIG. 3 shows a further apparatus 100′, with dispenser containers removed. In some embodiments therefore, the dispensers may be fixed in positions whereas in the present embodiment the dispensers are removable for cleaning.

### Dispensers 101, 103, 105

There are at least two dispensers required to dispense ingredients. Typically, one or more of the dispensers will dispense dry, often powdered or granular ingredients from respective containers, and one or more of the dispensers will dispense liquid ingredients. Presently there are three such dispensers 101, 103, 105, for dispensing a corresponding three ingredients (not shown). Each ingredient may be, for example:
(a) flour;
(b) water;
(c) oil;
(d) a dietary supplement—e.g. maca powder, fibre supplement, vitamin supplement and protein powder;
(e) ghee; or
(f) any combination of the above and/or another ingredient.

With reference to FIG. 4B, each dispenser 101, 103, 105 may comprise or be coupled to a respective container 102, 104, 106 (see FIGS. 4A and 4B) each containing one of the two or more ingredients. Each container 102, 104, 106 may be used to store the respective ingredient prior to use.

In general, at least one of the two dispensers 101, 103, 105 (there being a dispenser associated with each container 102, 104, 106) will contain or dispense a ground or powdered ingredient such as flour, and another of the two dispensers 101, 103, 105 will contain or dispense a liquid ingredient such as water or oil.

Each container 102, 104, 106 is in communication with a dispensing mechanism 114 as best seen in FIG. 5. The dispensing mechanism 114 is controlled by the control system 110 to dispense the respective ingredient from the container 102, 104, 106.

Each container 102, 104, 106 may be removably attached to a housing 12 of the apparatus 10, be fixed to or integral with the housing 12. The present disclosure is intended to encompass all configurations in which the container comes into, or is in, communication or engagement with the dispensing mechanism 114 to dispense the ingredient from the container 102, 104, 106.

Similarly, the dispensing mechanism 114 and container 102, 104, 106 may form separate parts of the apparatus 100, or be an integral unit.

Each dispenser 101, 103, 105 is controlled by the control unit 110 to dispense the respective ingredient. Each dispenser 101, 103, 105 is therefore selectively operated or actuated to produce the dispensing function. The type of dispensing mechanism 114 may depend on the ingredient—for example, the dispensing mechanism 114 may comprise a valve, for dispensing oil or water, or a worm-drive for dispensing dry substances such a flour.

For dispensing oil or water, each dispenser 101, 103, 105 may be a pumpless, tubeless fluid dispenser. In such embodiments, opening a valve of the dispensing mechanism 114 may cause oil, water or other fluid to drain from the container 102, 104, 106 until the valve is closed. Advantageously, avoiding pumps and tubing ensures a low number of mechanical parts are used, and also reduces redundant fluid volume in tubing. Reducing redundant fluid volume reduces wastage, makes the apparatus 100 easier to clean, and reduces contamination between batches of different types of flat edible.

In alternative embodiments, one or more of the dispensing mechanisms 114 may comprise an actuator (e.g., motor, pump, solenoid) to control a flow of ingredients.

### Weighing Device 108

With reference to FIG. 6, the weighing device 108 is for measuring a weight of each ingredient dispensed by dispensers 101, 103, 105. The weighing device 108 is part of a mixing unit 112, or is in operational engagement with the mixing unit 112 (i.e. is positioned against or relative to the mixing unit 112 to enable the load cell to weigh the ingredients in the mixing unit) that comprises a container 116 into which the ingredients are dispensed. The container 116 in each case is mounted on a base 118. Supporting the container 116 above the base 118, or otherwise between the container 116 and base 118, is the weighing device 108. The weighing device comprises a load cell arrangement 120.

The mixing container 116 is disposed within, or forms part of, a housing 122. The base 118 may be held in fixed relation relative to the housing 122, may be integrally formed with the housing 122, or otherwise held in sufficiently fixed position to ensure accurate weight measurements can be taken by the load cell arrangement 120.

The container 116 is substantially cylindrical. The load cell arrangement 120 may comprise a plurality of load cells—e.g. a plurality of load cells disposed equidistantly around a circumference of the bottom/base of the container 116—but presently comprises a single load cells that, in some embodiments, is circular or annular. The load cells spaced are equidistantly relative to a circumference of the bottom 124 of the container 116, between the bottom 124 and base 118. In other embodiments, the load cell arrangement comprises a single load cell located centrally of the bottom 124, two or more load cells, or an annular load cell in which a centre of the annulus is centred on a centre of the bottom 124.

The load cell arrangement 120 measures the weight of ingredients dispensed into the container 116.

### Mixing Unit 112

The mixing unit 112 receives and mixes the dispensed ingredients to form a mixture. The mixing unit 112 is intended to reproduce, to the extent possible, the results of the process that would otherwise be performed if the ingredients were manually worked.

Accordingly, the mixing unit 112 may be a processing unit, kneading unit, rolling unit, puncturing unit, and/or other unit for processing or working the ingredients to make the mixture, such as that described in WO2015097563 or WO2015097562, the entire contents of which are incorporated herein by reference. The mixture thus produced may take any desired shape. In the present embodiment, the mixture is formed into a generally rounded dough ball.

The mixing unit 112 receives the ingredients in a container—presently, the mixing unit 112 comprises the weighing device 108 and the container 116 of the weighing device 108 is thus also the container of the mixing unit 112. The container 116 includes a bottom 124 onto which the two or more ingredients are dispensed.

The ingredients enter the container 116 through a slot 126 or aperture 128 in a processing member 130 as shown in FIG. 7. In other embodiments, the ingredients enter the container through an aperture or opening in a sidewall of the container.

The processing member 130 may be configured to impart a desired processing technique on the ingredients, such as rolling, kneading, pressing and puncturing. The processing member 130 is configured to move relative to the bottom 124 to process the ingredients—i.e. the mix them into a doughball or similar. Presently, the processing member 130 is configured to rotate about a central axis 132 at a predetermined angular velocity, thereby to process the ingredients. The predetermined angular velocity is a velocity fast enough for the ingredients to be pushed together rather than flow or move out of the way of the blade or processing member 130, but is slow enough that it does not shear the ingredients instead of mixing them.

In some embodiments, the bottom 124 and/or the processing member 130 comprise one or more ribs or protrusions 134. Presently, both the processing member 130 and bottom 124 have ribs. In cases where the container is cylindrical, the ribs may extend radially from a central axis of the processing member 130—i.e. the processing member 130 may comprise a substantially circular plate with ribs 134 provided on an underside thereof. Similarly, each rib or protrusion of the bottom 124 may extend radially from the centre of the bottom 124. Each rib of the bottom resists movement of the ingredients around the bottom 124, while each rib or protrusion 134 of the processing member 130 moves ingredients around the bottom. Thus, the ingredients are worked to form a dough ball or other mixture.

A spacing between the bottom 124 and the processing member 130 may be determined to be approximately the height of a single dough ball, or may be otherwise predetermined according to the flat edible being produced. Alternatively, the processing member 130 may be configured to move vertically downwardly upon the ingredients in the container 116 until contact is achieved between the processing member 130 and the ingredients, to enable the ingredients to be worked or processed. For example, the processing member 130 may be mounted to a resilient member or spring (not shown) the presses the processing member 130 downwardly to account for variance in height of ingredients.

Contact between the processing member 130 and ingredients may be determined when the weighing device 108 measures an increase in force, applied to the bottom 124, commensurate with application of pressure to the ingredients by the processing member 130.

The processing member 130 is coupled to a motor (not shown). The motor may be operated at various speeds determined by the control system 110 in a process (e.g., instructions implemented in software) designed to produce a flat edible of the desired type—e.g. roti. The motor drives the processing member 130—e.g. in rotation—thereby to mix (including kneading and/or rolling) the ingredients.

During mixing of the ingredients, which may include kneading, rolling and other processes that occur when the ingredients are considered to already be “mixed”, the weighing device 108 may measure a weight force of the ingredients in the container 116. For a particular mixing operation, that weight force will be expected to have a particular value, or a particular value at a particular time period in the mixing operation. In this sense, a time period is a time or range (in seconds or some other measure) from when the mixing operation commenced or from when an additional amount of an ingredient was dispensed into the container 116 as described below.

If the weight force appears to be higher or lower than a predetermined amount, then the control system 110 determines that the mixture thus far produced is not of ideal consistency, or uses a particular type of ingredient—e.g. a specific type of flour. The change in weight my result from the processing member 130 having to apply more or less than a predetermined or expected amount of force to work the mixture. Where the control system 110 determines the mixture is stiffer than ideal, the control system 110 may cause one or more of the dispensers 101, 103, 105 to dispense an amount of a liquid ingredient. Conversely, where the control system 110 determines the mixture is softer than ideal, the control system 110 may cause one or more of the dispensers 101, 103, 105 to dispense an amount of a powdered or ground ingredient.

In an alternative embodiment, the motor is fitted with one or more sensors that measure energy usage of the motor operating the processing member 130 or, in some cases, the bottom 124 where the bottom 124 is moved relative to the processing member 130. Where energy usage is higher or lower than a predetermined amount, the control system 110 determines the consistency of the mixture is not a desired consistency. Thus, where higher energy usage indicates the processing member 130 (or bottom in some embodiments) is experiencing too high a resistance to movement, the control system 110 may introduce an amount of a liquid ingredient into the container 116. Similarly, lower energy usage may indicate the processing member 130 (or bottom in some embodiments) is experiencing too low a resistance to movement and the control system 110 may respond by introducing an amount of a solid, ground or powdered ingredient into the container 116. Thus, the control system 110 adjusts for inconsistencies in the mixture.

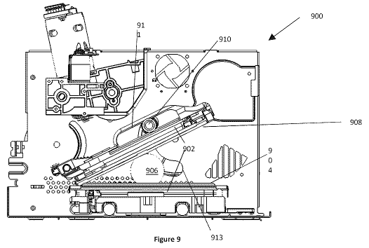

With reference to FIG. 8, the weighing device 108 may measure a weight force or changes in weight force (y-axis) over time (x-axis). At the outset 800, at time 0, the force is minimal. The predetermined amounts of ingredients may be introduced before or at time 0 or shortly afterward as shown. one or more ingredients may be dispensed concurrently or, per FIG. 8, a predetermined order may be used. IN the present embodiment, flour is dispensed before water, and water is dispensed before oil. Thus the ‘minimal’ force will be equal to that applied by the empty container 116, or equal to the total weight force of the predetermined amounts of ingredients, while at rest, unmixed. Alternatively, the mixing unit 112 may start moving prior to ingredients being introduced over period (A). At this stage, the weight force follows an expected profile (consistency profile—X). The expected profile corresponds to the reference consistency with which the control system 110 compares measurements to determine if the mixture is developing as expected. It will be understood that a small amount of variation from the expected profile may be acceptable. As such, the need to ultimately adjust the ratios of flour to water or oil may not be evident at the outset.

At some point during or after ingredients are dispensed into the container 116 and mixing progresses, if there are incorrect relative amounts of ingredients in the container 116 then the weight force will start to deviate from the expected profile (X)—see time period 1 (T-p 1) over which the deviation of force input over time from the expected profile X starts to increase. This period is the pre-mixing stage where the ingredients are mixed together in advance of kneading. It is expected that the weight force or force required to drive processing member 130 or bottom 124 will deviate somewhat until there are no boluses of individual ingredients remaining in the container 116, unmixed.

There is a notable force spike when the dough starts to form and gluten develops at the end of the pre-mixing stage. When gluten is developed, the load variation reduces and dough rounding commences. In the post kneading stage, the force deviation between profiles X, Y and Z reduces as the system moves the dough ball around the container to pick up residual dough.

If, after a predetermined amount of time or at any time-point (i.e. not limited to any particular stage in the process of FIG. 8), the load or weight force differential between the expected trajectory and the actual measured load or weight force is greater than a predetermined amount, the control system 110 will introduce an additional amount of one or more ingredients to correct the consistency of the mixture. Over time period 2 (T-p 2), the actual profile (Y) deviates from expected profile (X) by too great a load differential (802). Given the actual profile (Y) is lower than the expected profile (X), it indicates there is too much liquid in the mixture. The control system 110 may then either (i) dispense a predetermined additional amount of powdered/ground ingredient—e.g. 1 gram—into the container 116 and continue mixing, or (ii) calculate an amount of powdered/ground ingredient specific to the load differential and/or type of ingredients in the container 116, required to correct the consistency of the mixture—i.e. return the mixture back to or within an acceptable range from the expected profile (X)—see the load profile deviation at point 810. Conversely, the actual profile (Z) deviates from expected profile (X) by too great a load differential (804). Given the actual profile (Z) is higher than the expected profile (X), it indicates there is too little liquid in the mixture. The control system 110 may then either (i) dispense a predetermined additional amount of liquid ingredient—e.g. 1 gram or millilitre—into the container 116 and continue mixing, or (ii) calculate an amount of liquid ingredient specific to the load differential and/or type of ingredients in the container 116, required to correct the consistency of the mixture—i.e. return the mixture back to or within an acceptable range from the expected profile (X)—see the load profile deviation at point 808. The acceptable range may be within ±5% of the expected force, or some other acceptable range.

In essence, the control system 110 determines, based on measurements from the weighing device 108 and/or the mixing unit 112, whether the consistency of the mixture, as determined based on actual/measured load force or motor drive power usage, matches the reference/expected consistency (corresponding to the expected profile (X)). If there is a match, then the control system 110 does not adjust the ingredient amounts. If there is not a match, the control system 110 adjusts the ingredient amounts as set out above. Notably, a match may be found if the consistency or load force is within the acceptable consistency/load range of the expected value. Thus, the control system 110 causes additional ingredients to be dispensed by dispensers 101, 103, 105 when needed, to correct the consistency of the mixture.

An adjustment may occur outside any predetermined time period if, for example, the load is simply too great or deviates by too large a margin from the expected load profile. Moreover, the dough or mixture of optimal consistency may be generated by controlling a speed and rotations of the motor/processing member 130/bottom 124 based on feedback obtained by the control system 110, in addition to adjusting ingredient amounts.

Rather than adjust ingredient amounts during dough ball formation, the control system 110 may identify an appropriate adjustment and update the water to flour, flour to oil or oil to water ratio for a subsequent dough ball.

The measurement of load, driving force and so on may occur at any desired time period during mixing, or may be repeated at regular intervals or predetermined time periods (herein interchangeably used with “time points”—i.e. one or more specific points in time—unless context dictates otherwise).

The total amount of each ingredient introduced into the container (e.g. the total additional amounts introduced during a mixing process, or that total plus the predetermined amount initially dispensed) to produce a mixture of the desired consistency may be retained, e.g. by the control system 110 or a remote storage device. The predetermined amounts introduced into the container 116 for making a mixture for the next flat edible may therefore be adjusted to maintain the same proportions of each ingredient, to ensure the next flat edible and subsequent flat edibles can be produced faster, at the desired consistency. Moreover, to avoid making too large a mixture or doughball, the control system 110 may normalise the ingredients based on a predetermined total mixture weight. If the mixture is to weigh, for example, 65 grams, and an extra 6.5 grams of additional amounts of ingredients are dispensed during a processing cycle to correct the consistency of the mixture, then the total amounts of ingredients may be multiplied by 65/71.5 to bring the total updated, predetermined weights of ingredients back to 65 grams for the next processing cycle (i.e. the next time the mixing unit 112 is to make a mixture or doughball).

To determine driving force or load force, sensors are used. The sensor or sensors of the motor may be any appropriate sensor, such as a voltmeter or ammeter, that measures powered used by the motor to work the mixture using the processing member 130 or container bottom 124. If the power is too high, the mixture is too stiff and an ingredient—e.g. a liquid—should be introduced to reduce stiffness as discussed above. Similarly, if the power is too low, the mixture is not stiff enough and an ingredient—e.g. a ground or powdered ingredient—should be introduced to increase stiffness.

Accordingly, feedback is applied to the control system 110 which then controls the dispensers 101, 103, 105 to dispense additional amounts of particular ingredients to obtain a mixture of optimal consistency (e.g., automatic adjustment). In one or more embodiments, the user may specify an amount of grounded edible material and liquid to be dispensed or specify type and/or brand of flour (e.g., manual adjustment). These can be used as a baseline for determining the appropriate consistency of the mixture for the particular type of ingredient or tastes of the user.

The mixing unit 112 may be configured to generate one dough ball or mixture at a time. While the dough ball or mixture is being cooked as discussed below, the mixing unit 112 may commence mixing the next mixture. In alternative embodiments, the mixing unit may make a mixture of sufficient size to produce more than one flat edible, or may mix multiple separate mixtures at one time, each mixture being spaced circumferentially equidistantly on the bottom 124 of the container 116.

Advantageously, the control system 110 controls operation of the mixing unit 112. In some embodiments, the mixing unit 112 is operated for a pre-determined amount of time or an amount of time determined based on dough ball development—this can be determined from the amount of work done to the dough as discussed below. Moreover, the blade may be operated a speed that changes depending on the type of ingredients (e.g. specific type of flour), the volumes of ingredients and/or the type of flat edible being produced. The amount of time may be specific for the type of flat edible being made, the weight of ingredients in the mixture, or the types of ingredients—e.g. flour type. That time may be adjusted where additional amounts of ingredients are dispensed into the container 116, to account for the increased necessary mixing time to ensure consistency throughout the mixture.

In other embodiments, the mixing unit 116 may continue until the sensor(s) of the motor or weighing device 108 determine the consistency to be correct for a properly worked mixture. The mixing unit 116 may therefore mix the ingredients until the mixture reaches a desired consistency. The mixing unit 116 may continue to mix the mixture once the desired consistency is reached, to ensure the mixture maintains that consistency—rather than, for example, becoming stiffer.

In some embodiments, the rolling unit includes a top surface and a bottom surface, the top surface configured to move laterally parallel to the bottom surface. Advantageously, the distance between the top surface and the bottom surface is approximately the height of the mixture such that when the top surface moves laterally, the two or more dispensed ingredients are urged to form a substantially mixture.

In some embodiments, the processing unit is configured to press, rotate, blend, slice, chop, perforate and grind.

To form a mixture with the correct consistency, advantageously, the apparatus 100 includes the feature of correcting the consistency of the mixture. This feature may be embodied by the control system 110 being configured to:
(i) determine a consistency of the mixture;
(ii) compare the consistency of the mixture to a reference consistency to determine if the consistency and reference consistency are a match; and
(iii) if the consistency and the reference consistency are not a match, determine an additional weight of one or more of the ingredients, to be dispensed by the dispensers, required so that the consistency approaches or matches the reference consistency; and
(iv) cause the additional weight of the respective ingredients to be dispensed.

In some embodiments, the reference consistency is a consistency range and the control system determines if the consistency and reference consistency are a match by determining if the consistency is within the consistency range. For example, a look up table may be used determine if the consistency and reference consistency are a match.

Advantageously, the additional weight of one or more ingredients is determined by the control system 110 based on a consistency of the mixture as measured by the weighing device 108. The weighing device 108 may thus serve multiple purposes. For example, during dispensing of ingredients the weighing device 108 will measure a weight of each ingredient. A predetermined portion of each ingredient (e.g. 90%) may be dispensed rapidly, with the remainder (e.g. 10%) being dispensed slowly until 100% of the required amount has been dispensed. The weighing device 108 may then measure a load (i.e. weight) during mixing. As the blade mixes the ingredients, it “works” or “applies work to” the ingredients. The work encourages gluten development that then stiffens the mixture. The gluten development and resulting increased stiffness mean more force/work is required to mix the mixture/dough. The additional force results in a higher reading by the weighing device 108. Therefore, the work done to the mixture can be inferred from the load or weight sensed by the weighing device 108. The control system 110 uses these measurements to determine the weight of dispensed goods in periods when no mixing is occurring, and to determine the work applied to the mixture/dough during periods when mixing is occurring.

Preferably, the weighing device is further configured to measure the consistency of the mixture after the step of mixing the dispensed two or more ingredients to form a mixture, or at one or more time periods during mixing.

In some embodiments, the type of one of the two or more ingredients, e.g. flour, is detected. For example, the load profile as measured by the weighing device 108 is used to detect the type of flour used. The rate at which dough develops, and the stiffness when the dough is fully developed, will change depending on the type of flat edible being produced, the types of ingredients and/or their volumes. Therefore, the control system 110 may compare dough development to a development profile—i.e. compared the amount of work over time to a reference profile of the amount of work expected to be done over time for the particular flat edible, volumes of ingredients and/or types of ingredients. Based on that comparison the control system 110 may adapt the mixture by adding one or more further additional predetermined ingredient amounts.

In some embodiments, the apparatus 100 is configured to predict the predetermined weight of the two or more ingredients to be dispensed by dispensers 101, 103, 105 based on user input such as nutrition labels or information. With reference to apparatus 900 in FIG. 9, the control system 110 can adjust the amount of time the mixing unit mixes the mixture or the amount of time the heating mechanism 902 heats the flattened mixture to adjust for the user input.

The container 116 is used for mixing and kneading the ingredients. In some embodiments, the bottom 124 of the container 116 opens (e.g. is hinged) to allow the doughball to drop from the container 116 onto a cooking/heating platen 904 and/or to a transfer mechanism for properly positioning the mixture (e.g. doughball 906) on the cooking/heating platen 904—i.e. in a position to facilitate cooking of the mixture. In other embodiments, the container 116 tips to roll the mixture 906 from the top of the container 116 either into a transfer mechanism and/or onto the heating/cooking platen 904. In other embodiments, the base of the container 116 may itself form a transfer mechanism for taking the mixture from the container 116 and positioning it on the heating/cooking platen 904. Where the bottom 124 is not integral with the rest (e.g. sidewalls) of container 116, the bottom 124 may be held tightly (e.g., by the vertical transfer unit) to the rest of the container 116 and sealed to ensure that there is no leakage during mixing.

### Control System 110

The control system 110 controls operation of the apparatus 100. To this end, the control system 110 may store instructions for operation of the apparatus 100, may receive instructions from a remote source, or a combination of the two.

The control system 110 may be a single unit or component mounted in the apparatus 100, or may be distributed such that, for example, one of more of the dispensers 101, 103, 105, weighing device 108 and mixing unit 112 comprise at least a part of the control system 110.

The control system 110 is further configured to cause the two or more dispensers 101, 103, 105 to dispense a predetermined weight, the predetermined weight being one of the following:
(a) a collective weight of the two or more ingredients;
(b) an individual weight of each ingredient of the two or more ingredients; and
(c) an additional weight of one or more ingredients as determined during mixing.

In some cases, the control system 110 controls the dispensers 101, 103, 105 to dispense the two or more ingredients continuously. Advantageously, the weighing device 20 is configured to communicate with the control system 12 and provide the dispensed weight of the ingredient to the control system 110 so the control system 110 can stop the ingredients being dispensed at the appropriate time (this may differ between ingredients). The control system 110 may also stop dispensing an ingredient shortly before the weighing device 108 determines the container 116 contains enough of that ingredient. This will ensure that any ingredient falling into the container, that has not yet come to rest on the bottom 124 and thus been measured by weighing device 108, does not result in the total weight of the mixture, or weight of a particular ingredient, exceeding a predetermined weight. The control system 110 may do this a predetermined amount of time before it expects the weighing device 108 to weigh the full, predetermined amount of that ingredient—e.g. if an ingredient is being dispensed at 10 grams/second, and it take half a second for the ingredient to leave the dispenser and be measured on the bottom 124, then the control system 110 may cease dispensing of that ingredient when the weighing device 108 measures the dispensed amount of the ingredient to be 5 grams less than the predetermined weight. To this end, it can be desirable to dispense the ingredients sequentially, so a specific weight of individual ingredients can be accurately dispensed.

In some embodiments, the apparatus 100 further includes one or more of the following:
(a) flattening mechanism for flattening the mixture to form a flattened mixture; and
(b) heating mechanism 902 for heating the flattened mixture to obtain a cooked flat edible.

Preferably, the components 902, 908 of apparatus 100 are configured to be in communication with control system 110. In some embodiments, apparatus 100 is in communication with communication network 200 as discussed below. Communication network 200 may include the Internet, telecommunications networks and/or local area networks, from which to download recipes and updates to the apparatus 100.

### Flattening Mechanism

In some embodiments, the flattening mechanism includes a first plate 904 and a second plate 908 movable with respect to the first plate 904, to flatten the mixture 906.

Preferably, the second plate 908 is pivotally movable with respect to the first plate 904, to flatten the mixture. Advantageously, the pivoting movement of the plates allows for a mixture to be flattened into a substantially uniform thickness flattened mixture. That pivoting movement is driven by a drive shaft 910 travelling in slot 911. Shaft 910 travels around an arcuate path 913. As it travels along that path 913, it travels along slot 911 and progressively lowers and raises the platen 908.

### Heating Mechanism 902

In some embodiments, the heating mechanism 902 is a heat source that heats the platens 904, 908, so that the platens 904, 908 cook the mixture 906 after flattening it.

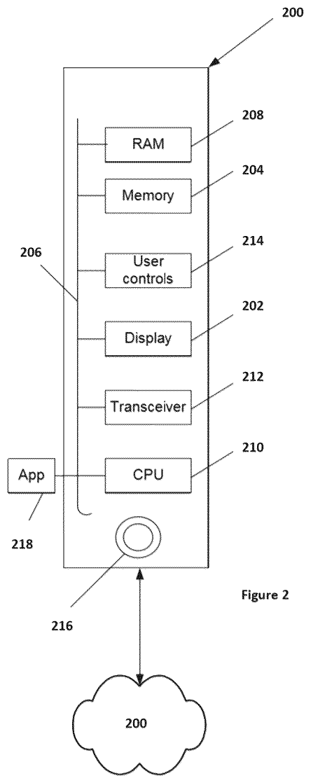

With reference to FIG. 2, the apparatus 100 comprises various system components that interact to control the apparatus 100 and enable user inputs or other external inputs to be used. FIG. 2 is a block diagram showing an exemplary computer device 200, e.g. a mobile computer device, for use in an adaptive mixing system or apparatus for making flat edibles. The computer device 200 may be any desired device though, in general, will form part of the apparatus for making flat edibles, or of the adaptive mixing system within that apparatus.

As shown, the computer device 200 includes the following components in electronic communication via a bus 206:
(a) a display 202;
(b) non-volatile (non-transitory) memory 204;
(c) random access memory (“RAM”) 208;
(d) N processing components 210;
(e) a transceiver component 212 that includes N transceivers; and
(f) user controls 214.

Although the components depicted in FIG. 2 represent physical components, FIG. 2 is not intended to be a hardware diagram. Thus, many of the components depicted in FIG. 2 may be realized by common constructs or distributed among additional physical components. Moreover, it is certainly contemplated that other existing and yet-to-be developed physical components and architectures may be utilized to implement the functional components described with reference to FIG. 2.

The display 202 generally operates to provide a presentation of content to a user, and may be realized by any of a variety of displays (e.g., CRT, LCD, HDMI, micro-projector and OLED displays). The display 202 may be a touchscreen for receiving inputs for controlling the cooking process or a number of flat edibles or mixtures to be produced.

In general, the non-volatile data storage 204 (also referred to as non-volatile memory) functions to store (e.g., persistently store) data and executable code.

In some embodiments for example, the non-volatile memory 204 includes bootloader code, modem software, operating system code, file system code, and code to facilitate the implementation components, well known to those of ordinary skill in the art, which are not depicted nor described for simplicity.

In many implementations, the non-volatile memory 204 is realized by flash memory (e.g., NAND or ONENAND memory), but it is certainly contemplated that other memory types may be utilized as well. Although it may be possible to execute the code from the non-volatile memory 204, the executable code in the non-volatile memory 204 is typically loaded into RAM 208 and executed by one or more of the N processing components 210.

The N processing components 210 (forming the control system) in connection with RAM 208 generally operate to execute the instructions stored in non-volatile memory 204. As one of ordinarily skill in the art will appreciate, the N processing components 210 may include a video processor, modem processor, DSP, graphics processing unit (GPU), and other processing components.

The transceiver component 212 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks. This can allow the apparatus 200 to update based on new cooking profiles acquired from a remote server, different ingredient profiles and other considerations.

Reference 216 represents inputs obtained from the apparatus or mixing unit itself, such as sensor inputs for determining load on the mixing unit, measurements from the weighing device, temperatures of heating platens and others, that can be fed to the N processing components 210 to ensure accurate control of the mixing and/or cooking processes, or updating of ingredient amounts (stored in non volatile memory 204) for future cooking cycles.

It should be recognized that FIG. 2 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 204. Non-transitory computer-readable medium 204 includes both computer storage medium and communication medium including any medium that facilitates transfer of a computer program from one place to another. A storage medium may be any available medium that can be accessed by a computer.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. An adaptive mixing system for use in producing flat edibles, comprising:
(a) two or more dispensers for dispensing two or more ingredients;
(b) a mixing unit for receiving and mixing the dispensed two or more ingredients to form a mixture;
(c) a weighing device associated with the mixing unit, to weigh amounts of ingredients received in the mixing unit; and
(d) a control system configured to cause the two or more dispensers to dispense a predetermined weight, as measured by the weighing device, of each ingredient of the two or more ingredients,
wherein the control system is further configured to:
(i) determine a consistency of the mixture based on measurements from one or both of the mixing unit and the weighing device;
(ii) compare the consistency to a reference consistency to determine if the consistency and reference consistency are a match;
(iii) if the consistency and the reference consistency are not a match, determine an additional weight of one or more of the ingredients, to be dispensed by the dispensers, required so that the consistency approaches or matches the reference consistency; and
(iv) cause the additional weight of the respective ingredients to be dispensed.

2. The system according to claim 1, wherein the additional weight of one or more ingredients is determined by the control system based on a consistency of the mixture as measured by the weighing device and a consistency profile.

3. The system according to claim 1, wherein the mixing unit is one or more of the following:
(a) a kneading unit;
(b) a rolling unit; and
(c) a processing unit.

4. The system according to claim 1, wherein the reference consistency is a consistency range and the control system determines if the consistency and reference consistency are a match by determining if the consistency is within the consistency range.

5. The system according to claim 4, wherein the reference consistency comprises a time-based profile and, at one or more time periods during mixing, the control system determines if the consistency and reference consistency are a match by determining if the consistency is within the consistency range applicable at a corresponding said time period.

6. The system according to claim 1, wherein the weighing device is further configured to measure the consistency of the mixture after the step of mixing the dispensed two or more ingredients to form a mixture.

7. The system according to claim 1, wherein the control system performs steps (i) and (ii) on two or more occasions during mixing, and performs steps (iii) and (iv) if step (ii) determines, on each respective occasion, that there is not a match.

8. The system according to claim 1, wherein upon completion of mixing of the mixture, the control system is adapted to update the amounts of the two or more ingredients based on the additional weight for each respective ingredient, dispensed during mixing.

9. The system according to claim 8, wherein the control system performs steps (i) and (ii) on two or more occasions during mixing, and performs steps (iii) and (iv) if step (ii) determines, on each respective occasion, that there is not a match, wherein the additional weight is a total additional weight of each respective ingredient dispensed on all occasions during mixing.

10. The system according to claim 8, wherein the control system updates the amounts by:
determining a total weight of each ingredient required for the consistency to match during mixing; and
normalising the ingredients based on a predetermined total mixture weight.

11. An apparatus for producing flat edibles comprising the system according to claim 1.

12. The apparatus according to claim 11, further including a flattening mechanism for flattening the mixture to form a flattened mixture.

13. The apparatus according to claim 12, wherein the flattening mechanism includes a first plate and a second plate movable with respect to the first plate, to flatten the mixture.

14. The apparatus according to claim 11, further including heating mechanism for heating the flattened mixture to obtain a cooked flat edible.

15. The apparatus according to claim 14, wherein the heating mechanism comprises a radiant heat source.

16. The apparatus according to claim Z, further comprising a transfer mechanism for transferring the flat edible from the apparatus.

17. The apparatus according to claim 16, wherein the transfer mechanism is configured to transfer the mixture from the mixing unit to the flattening mechanism.

18. The apparatus according to claim 17, wherein the transfer mechanism is configured to place the mixture on a pre-determined location with respect to the flattening mechanism.
